(19) United States
(12) Patent Application Publication
(10) Pub. No.: US 2004/0192811 A1
(43) Pub. Date: Sep. 30, 2004

(54) Corrugating adhesive comprising a starch, hemicellulose and polyvinyl alcohol complex and process for making same

(76) Inventor: Roman Skuratowicz, Hickory Hills, IL (US)

Correspondence Address: NORRIS MCLAUGHLIN & MARCUS, P.A., P O BOX 1018, SOMERVILLE, NJ, 08876

(21) Appl. No.: 10/401,657

(22) Filed: Mar. 28, 2003

(51) Int. Cl. C08L 3/00

(52) U.S. Cl. 524/47; 524/50; 524/51; 524/52; 524/55

(57) ABSTRACT

The invention pertains to a corrugating adhesive comprising a starch, which may be cooked, hydrocolloid and polyvinyl alcohol complex. The corrugating adhesive is made by combining the hydrocolloid, starch and polyvinyl alcohol in the presence of a cross-linking agent and mixing to form a complex. The hydrocolloid may comprise hemicellulose.

### BACKGROUND OF THE INVENTION

1. Field of the Invention

The invention pertains to corrugating adhesives and additives for corrugating adhesives, comprising starch, hydrocolloid, preferably hemicellulose, and polyvinyl alcohol. The corrugating adhesive is made by combining the hydrocolloid, starch and polyvinyl alcohol in the presence of a cross-linking agent and alkali with cooking resulting in the formation of a new complex having cross-linked hydroxyl groups on the starch, polyvinyl alcohol and hydrocolloid.

2. The Prior Art

In the corrugating process, adhesive is commonly applied to the tips of the flutes of a corrugated medium. Then a non-corrugated flat paper liner is applied against the adhesive coated flutes as they pass between a corrugating roll and a pressure roll. The resulting product has the corrugating medium on one side and a flat liner on the other side and is called a single-face portion. The single-face portion may be used “as is” (called a “single-face” board) or adhesive may be applied to the flute tips of the single-face portion and a second flat sheet can be applied in the same manner as the first in what is called a “double-face” or a “double-back” operation. The second liner sheet is treated with heat and reduced pressure (relative to the pressure used to make a single-face portion) immediately following contact with the adhesive coated flutes as they pass between a corrugating roll and a pressure roll.

Starch-based adhesives which can be of the carrier, no-carrier and carrier no-carrier type are commonly used in processes for manufacturing corrugated paper board. In carrier type adhesives, a portion of the starch (or dextrin) forms a carrier, often known as the gelatinized phase, which suspends the balance of the starch which is in an ungelatinized state. Under conditions of heat and pressure, the ungelatinized starch is rapidly hydrated and gelatinized to increase quickly the viscosity and adhesivity of the adhesive composition. In no-carrier type adhesives, all of the starch is slightly cooked or swollen with heat and caustic soda for viscosity. Finally, carrier no-carrier type adhesives have a portion of the starch which forms a carrier and is responsible for about one half of the viscosity and the remaining viscosity is obtained by slightly swelling the uncooked starch.

Starch based corrugating adhesives of the carrier, no-carrier and carrier no-carrier type comprising added hemi-cellulose are described U.S. Pat. No. 5,358,559. Adhesive compositions where the hemicellulose is extracted from corn fiber in situ during the process of preparing the carrier phase are discussed in U.S. Pat. No. 6,368,443 B1.

Starch based corrugating adhesives comprising polyvinyl alcohol with an intermediate degree of hydrolysis, starch alkali metal hydroxide, a boric acid compound and an optional cross-linking agent are described in U.S. Pat. No. 5,093,393. The polyvinyl alcohol is said to impart a definite increase in the rate of viscosity building to the adhesives described in U.S. Pat. No. 5,093,393.

We have discovered that combining hydrocolloid, preferably hemicellulose, starch and polyvinyl alcohol in the presence of a cross-linking agent at high alkali with cooking results in a corrugating adhesive comprising a complex of cross-linked hydroxyl groups on starch, polyvinyl alcohol, and hydrocolloid. This complex has a measurably different molecular weight distribution from the corresponding components as measured by size exclusion chromatography. The corrugating adhesives of the invention have significant increase in tack and other performance enhancements compared to adhesives in the art comprising a fiber component or a polyvinyl alcohol component.

In the present Specification all parts and percentages are on a weight by weight basis, unless otherwise specified.

### SUMMARY OF THE INVENTION

The corrugating adhesives comprise starch (including modified starch), hydrocolloid, preferably hemicellulose, polyvinyl alcohol, caustic, a cross-linking agent, such as borax or other boron containing compounds, and water. The starch may be cooked starch. Optionally, the corrugating adhesive comprises other additives and fillers, such as waterproofing or water resistant resins, biocides, anti-foaming agents and performance enhancing compounds such as latex emulsions based on acrylics and copolymers of styrene. The hydrocolloid, starch and polyvinyl alcohol is in the form of a complex having cross-linked hydroxyl groups resulting in a corrugating adhesive having significant increase in tack and other performance enhancements. Dextrin may be used in place of or with the starch in the corrugating adhesive in which case the complex comprises cross-linked hydrocolloid, starch and/or dextrin and polyvinyl alcohol, and it should be understood that reference in this Specification and the appended claims to starch shall refer to modified or unmodified starch or dextrin, or combinations of starch (either modified or unmodified) and dextrin, all of which may be cooked.

The corrugating adhesive complex is made by combining at least the hydrocolloid, starch and polyvinyl alcohol in the presence of a cross-linking agent, such as borax, and alkali, such as sodium hydroxide, with cooking. The corrugating adhesive complex may be made as part of a carrier portion of a corrugating adhesive or may be made separately and added to a corrugating adhesive. Additionally, the hydrocolloid and polyvinyl alcohol can be added separately or as a blend to a prepared corrugating adhesive that has sufficient alkali and cross-linking agent to form the complex. In this embodiment, additional heating to cook the starch may not be necessary to form the corrugating adhesive complex as long as the hydrocolloid and a sufficient amount of starch is in suitable form to serve as a carrier for the corrugating adhesive.

The hydrocolloid may be added to a corrugating adhesive or may be made in situ from fiber by alkali extraction when making the corrugating adhesive composition. The adhesive may be of the carrier, no-carrier and carrier no-carrier type. The hydrocolloid, starch and polyvinyl alcohol complex may be all or part of the starch component of the carrier portion of an adhesive comprising carrier or may be a component of the total starch in the adhesive composition. In embodiments of the invention wherein the adhesive comprises a carrier, the corrugating adhesive is made by use of a primary and a secondary mixer, with the temperature of each mixer and shear applied during mixing such that cooking occurs. The corrugating adhesive may also be made in other conventional preparation systems, such as a single mix tank, high shear mixer or minocar system provided that the temperature and shear are sufficient to cook the starch. In no-carrier embodiments of the invention, one or more mixers can be used provided that the temperature of one or more of the mixers and shear applied during mixing will cook the starch. The complex may also be created by adding hemicellulose and polyvinyl alcohol to a completed adhesive comprising starch and a boron containing compound and subjecting this mixture to the appropriate temperature and shear to cook the starch.

The invention also pertains to an additive that can be used to increase the tackiness of corrugating adhesives. The additive comprises the hydrocolloid, starch and polyvinyl alcohol complex in either solid or liquid form. The additive can be made by combining starch, hydrocolloid, preferably hemicellulose, and polyvinyl alcohol in a mixer with water, alkali and cross-linking agent and then applying temperature and high shear mixing to cook the starch and separating the thus formed starch, hydrocolloid and polyvinyl alcohol complex by alcohol precipitation. Fiber may be used for in situ preparation of hydrocolloid, particularly hemicellulose.

### DESCRIPTION OF THE DRAWING

FIG. 1 is a graph that compares the molecular weight distribution, as determined by size exclusion chromatography, of polyvinyl alcohol (CELVOL® 203 from Celanese Chemicals) and a compound formed by the mixture of the polyvinyl alcohol and borax at a pH of 11.5.

FIG. 2 is a graph of the molecular weight distribution, as determined by size exclusion chromatography, of the components of a mixture comprising hemicellulose, polyvinyl alcohol (CELVOL® 203 from Celanese Chemicals) and a borated complex of hemicellulose and polyvinyl alcohol.

FIG. 3 is a graph of the molecular weight distribution, as determined by size exclusion chromatography, of the components of the carrier adhesive of Example 1.

### DETAILED DESCRIPTION OF THE INVENTION

The corrugating adhesives are aqueous emulsions comprising a complex of starch, particularly cooked starch, hydrocolloid and polyvinyl alcohol having cross-linked hydroxyl groups, alkali, boron containing compound and water. The corrugating adhesive preferably comprises from about 15% to about 45% starch, about 1% to about 20% hydrocolloid, about 0.1% to about 10% polyvinyl alcohol, sufficient alkali to obtain a pH of about 10 to about 14, about 1% to about 3% boron containing compound and about 50% to about 80% water. The corrugating adhesive may further comprise additives and fillers, preferably including up to about 5% waterproofing or water resistant resins, up to about 5% biocides and up to about 5% performance enhancing compounds such as latex emulsion-based acrylics and copolymers of styrene. The corrugating adhesive composition may be of the carrier, no-carrier and carrier no-carrier type.

Both natural unmodified starch and modified starch can be used. Any starch appropriate for use in corrugating adhesives may be used and dextrin, as well as combinations of starch types, dextrin types and combinations of starches and dextrins.

Unmodified starch is a commodity chemical produced from the root, stem or fruit from a number of plants. It is a high molecular weight carbohydrate polymer which is comprised of linear and branched polysaccharide polymers and it can have moisture content from about 8% to about 20%, most commonly from about 11% to about 13%. Starches such as those derived from corn, wheat, barley, tapioca, rice, potato and/or other suitable plant source, and the like are suitable, as are hybrids. Blends of starches from various sources also can be used. Pearl starches and powdered starches may be used.

The modified starch which is used in accordance with the invention can be mechanically, chemically or heat modified. Compared to unmodified starches, modified starches frequently possess superior physical properties such as increased solubility, better film forming, increased whiteness, improved gel strength, viscosity stability, increased adhesivity, improved resistance to shear and increased resistance to freeze-thaw degradation. Starches derived from other genetic forms of corn, such as high amylose and waxy corn, as well as sorghum varieties, would also be suitable. Chemically modified starches useful in the invention include modified oxidized starch such as hypochlorite-oxidized starch, acid thinned starches, cross-bonded starch,; etherified starches, esterified-starches and others which have reduced molecular weight, high fluidity and/or functional sub groups.

Examples of chemically modified starches which can be used in the invention and are commercially available are SUREBOND® Industrial Corn Starch or STABLEBOND® (Industrial Corn Starch. These modified starches have residual carboxyl functionality and extreme uniformity and are available from Corn Products International, Inc., Westchester, Ill., U.S.A. (“Corn Products”).

The preferred hydrocolloid for use in the invention is hemicellulose. Hemicelluloses are described in U.S. Pat. No. 5,358,559 which is incorporated herein in its entirety by reference. The hemicellulose is preferably provided in situ by the addition of fiber when making the corrugating adhesive composition, however, purified forms of hemicellulose can be used. Other hydrocolloids with similar chemistry to hemicellulose, including gum arabic, xanthan gum, gum karaya, tragacanth, sodium alginates, carageenan, Guar gum, Locus bean gum, tara, pectins, gellan, cellulose derivatives such as carboxymethyl, methyl or ethyl cellulose, microcrystalline cellulose, or other polysaccharide type hydrocolloids can be used. Combinations of hydrocolloids may be used. The hydrocolloid may be chemically or enzymatically modified hydrocolloids, such as cellulose derivatives and enzymatically treated hemicellulose, like those referred to in U.S. Pat. No. 5,358,559 that are available under the trade name CELLACE from Nihon Shokuhin Kako Co. Ltd., Tokyo, Japan.

Starch hemicellulose blends may be used in place of or with the starch component to provide the corrugating adhesive composition with hemicellulose. These blends are particularly useful for use in the carrier portion of the invention. Starch hemicellulose blends available under the trademark FIBERBOND® Industrial Corn Starch from Corn Products may be used in the invention.

The hemicellulose is preferably extracted from corn fiber in situ when making the corrugating adhesive. Fiber sources include spent flake fiber, corn hull fiber, or other vegetable or seed fibers, preferably rich in hemicellulose. Suitable corn fibers include crude fiber, typically described as feed, and more finished products such as dietary corn fiber which is made for human consumption. Crude fiber or feed generally contains from about 20% to about 40% hemicellulose and dietary corn fiber generally contains from about 50% to about 80% hemicellulose. When dietary corn fiber is employed, the amount used is preferably from 0.1 to about 5.0 parts per 100 parts of adhesive. The fiber in the adhesive, or in a carrier phase, preferably has a particle size of less than about 0.0005 inch and a geometric mean size of less than about 0.00005 inch.

In embodiments of the invention wherein the adhesive composition comprises a carrier, preferably from about 20% to about 50% fiber, from about 2% to about 4% polyvinyl alcohol (both by weight of carrier components) and other carrier ingredients are combined to extract the hemicellulose in situ and make the carrier portion of the corrugating adhesive. In corrugating adhesives that do not comprise a carrier, preferably about 1% to about 10% fiber, about 0.1% to about 4% polyvinyl alcohol and the other components of the corrugating adhesive are combined to extract the hemicellulose in situ and make the corrugating adhesive.

Polyvinyl alcohol is a polyhydroxy secondary alcohol derived from a series of vinyl alcohol monomer units which by themselves do not exist. The polymer is manufactured first as polyvinyl acetate. Its molecular weight can be controlled by varying the polymerization conditions. The average molecular weight generally ranges from about 9,000 to 186,000 molecular weight units, but can be lower or higher. Depending on the polymer properties which are desired for a particular application, the acetate is then hydrolyzed, but not necessarily to completion. The degree of hydrolysis can theoretically range from 0 to 100%, but commercially available products generally range from about 78% to 100% (which means there can be anywhere from 0 to about 22% residual acetate functionality present in the polyvinyl alcohol in commercially available products). Tackified grades of polyvinyl alcohol derived from fully hydrolyzed polyvinyl alcohol which are already borated are also available commercially. It has been determined that these products provide improved water resistance, but many of them are highly viscous, not easily dispersible, and can cause gelation problems in corrugating applications.

The chemistry and properties of polyvinyl alcohol are discussed in detail in the Encyclopedia of Polymer Science and Technology, Volume 14, Chapter V (John Wiley & Sons, Inc., 1971) which is incorporated in its entirety herein by reference. In particular, solubilities are discussed on pages 162 and 163 where it is indicated that partially hydrolyzed polyvinyl alcohols are cold water soluble and more fully hydrolyzed polyvinyl alcohols are not. Cold water solubility is generally measured in the industry at an ambient temperature of 22° C. using a stirrer.

The polyvinyl alcohol which is used in accordance with the invention is cold water soluble, has a molecular weight of less than about 30,000, preferably less than about 15,000, and most preferably less than about 11,000 molecular weight units, and has a degree of hydrolysis of greater than about 90%, preferably greater than about 92%. Suitable commercially available polyvinyl alcohols include those from Celanese Chemicals, Dallas, Tex., U.S.A. under the tradename CELVOL®, however, polyvinyl alcohol from other manufacturers and suppliers may also be used. The viscosity of the polyvinyl alcohols used in accordance with the present invention range from about 2 centipoise to about 20 centipoise, preferably from about 2 centipoise to about 4 centipoise, at a temperature of 68° F. (20° C.) in a 4% aqueous solution.

Any strong base can be used for the alkali in the corrugating adhesives. Preferably, however, alkali metal hydroxides, such as sodium hydroxide or potassium hydroxide, are used. Combinations of alkalis may also be used.

The cross-linking agent is preferably a boron containing compound having free hydroxyl groups attached to the boron atoms, such as commercial boric acid (ortho boric acid, H₃BO₃ and its hydrated forms H₃BO₃.H₂O) and borax (sodium tetraborate decahydrate, Na₂B₄O₇.10H₂O and other hydrate and anhydrous forms). Borax is the most preferred cross-linking agent.

The corrugating adhesive may optionally comprise waterproofing resins. Any waterproofing resins appropriate for corrugated boards may be used. Preferred waterproofing or water resistant resins include those which upon heating in basic media generate cross-linking species which react and cross-link with any available hydroxyl group in the starch, polyvinyl alcohol, hemicellulose or cellulose molecules of the complex. The cross-linking action reduces the hydrophilic nature and water-solubility of the starch, hemicellulose, and other polyhydroxy molecules by effectively removing the availability of hydroxyl groups to water and by developing hydrophobic, aliphatic cross-linking moieties. Condensation products from the reaction of a ketone and aldehyde compounds are suitable. These resins are characterized as polyether polymers, but can contain a variety of other monomers such as urea, melamine, and the like. Waterproofing resins available from the Harper/Love Adhesive Corporation, Charlotte, N.C., U.S.A. (“Harper/Love”) under the trade names AQUASEAL PLUS™, AQUASEAL™ and HYDRATITE™ may be used in the invention.

The corrugating adhesives may, optionally, include biocides. Any composition appropriate for retarding microbial growth in corrugating adhesives may be used in the invention. Preferred biocides are those available from Harper/Love under the HARLO-CIDE™ trade name. Biocides available from The Dow Chemical Company, Midland, Mich., U.S.A. under the trade name DOWCIL®, particularly DOWCIL®75, may also be used.

The corrugating adhesives are preferably made by solubilizing the hydrocolloid, most preferably hemicellulose, in situ when making the adhesive. The preferred corn fiber is dietary corn fiber, such as that available from Corn Products, under the trademark PEERLESS®, containing from about 50% to about 80% hemicellulose and it can be prepared according to U.S. Pat. Nos. 4,994,115 or 5,073,201, which are incorporated herein in their entirety by reference.

No-carrier adhesives can be made by admixing for about 5 minutes to about 60 minutes hydrocolloid in a mixer with the alkali, starch, polyvinyl alcohol, boron containing compound and water, and any other ingredients of the corrugating adhesive compositions and mixing at elevated temperature to cook the starch. Preferably, the no-carrier adhesives are made at a temperature above about 100° F. which promotes rapid formation of the complex. The speed of the formation of the complex will depend on the amount of alkali, total shear and temperatures. Sufficient alkali must be added to attain a pH from about 10 to about 14, preferably from about 12to about 14. Preferably, the hydrocolloid is hemicellulose and is obtained in situ by the addition of corn fiber, most preferably by combining about 1% to about 10% fiber and about 0.1% to about 2% polyvinyl alcohol with the other ingredients. The most preferred starch for the no-carrier adhesive is pearl starch. During mixing, the complex forms and the starch becomes cooked, i.e gelatinized. Typical times for complex formation are from several seconds, e.g. at least about 2 seconds, to less than about 15 minutes depending on reaction conditions.

Carrier and carrier no-carrier adhesives are preferably made by the following primary/secondary process:

1. Water, starch, hydrocolloid, and polyvinyl alcohol, preferably about 2% to about 4% by weight of the carrier components, are mixed in a primary mixer and heated for at least about 1 minute and preferably from about 1 minute to about 25 minutes at a temperature of from about 115° F. (46° C.) to about 180° F. (82° C.). Preferably, the hydrocolloid is hemicellulose and is obtained in situ by the use of about 20% to about 50%, by weight of the carrier components, corn fiber in the process.

2. An aqueous solution of caustic in an amount to a attain pH from about 10 to about 14, preferably from about 12 to about 14 is added. Mixing is continued for at least about 10 minutes and preferably from about 10 to about 40 minutes.

3. Optionally, some or all of the boron containing compound, e.g. borax or boric acid, can be added to the primary mixer in which event cooking of the starch and complex formation will occur in the carrier phase. The boron containing compound, however, can be added to the secondary phase as discussed below.

4. Additional water is added and mixing is continued for at least about 1 minute and preferably from about 1 to about 15 minutes, most preferably from about 5 to about 8 minutes, to make a carrier phase.

5. A secondary mixer is charged with water, heated to from about 70° F. (21° C.) to about 105° F. (41° C.), preferably from about 90° F. (32° C.) to about 100° F. (38° C.) and boron containing compound, e.g. borax or boric acid, is added unless all of the boron containing compound was added to the primary mixer in the carrier phase.

6. Starch is added to the secondary mixer, and waterproof resin can be added as an option, to make a suspended phase (also called a suspended starch phase), and the contents are mixed in the secondary mixer for from about 3 to about 25 minutes.

7. The contents of the primary mixer are gradually added to the secondary mixer with continuous mixing at a temperature of about 80° F. to about 120° F. cooking the starch and forming the starch, hydrocolloid and polyvinyl alcohol complex. This step typically is carried out over a period of about 5 to about 20 minutes. Other additives and fillers may be also be added.

The invention also pertains to a method for bonding corrugated media and liners and making corrugated board comprising joining a corrugated medium to at least one liner coated with a waterproof or chemically resistant liner using the corrugating adhesive described herein. For example, a method for making a single-face board may comprise the steps of applying the adhesive composition of the invention onto the tips of the flute to a first side of a sheet of corrugated medium having a first and second side each with a plurality of flutes comprising tips and then applying paper liner by aligning the coated paper with the first side of the corrugated medium while simultaneously passing the coated paper liner and corrugating media through a corrugating roll and a pressure roll. A double-face portion can be made by applying the adhesive composition of the invention onto the tips of the flute to the first side and second side of a sheet of corrugated medium and then applying a first paper liner to the first side of the corrugating medium and a second paper liner to the second side of the corrugated medium by aligning the first sheet of paper with the first side of the corrugated medium and the second sheet of paper with the second side of the corrugated medium while simultaneously passing the paper and corrugating media through a corrugating roll and a pressure roll. In addition the adhesive can also be used on laminating and other gluing operations which involve heat and pressure curing of adhesives to bond papers together.

The invention also pertains to an additive for corrugating adhesives that increases the tackiness of the adhesive. The additive comprises hydrocolloid, starch and polyvinyl alcohol in a complex having cross-linked hydroxyl groups. The additive can be either in liquid or solid form. The starches, hydrocolloids and polyvinyl alcohol discussed herein for the corrugating adhesives may be used in the additive.

The additive is made by combining starch, hydrocolloid and polyvinyl alcohol with water, alkali, such as those discussed herein, and a boron containing compound, e.g. boric acid or borax, in a mixer. The contents are then mixed at a temperature of about 90° F. to about 150° F. to cook the starch and form the hydrocolloid, starch and polyvinyl alcohol complex having cross-linked hydroxyl groups. The complex may additionally be purified by alcohol precipitation, ion exchange, separation by centrifugation or ultrafiltration, dried or used as a liquid with no additional processing. Fiber may be used for in situ preparation of hemicellulose as the hydrocolloid portion in the process.

The invention also pertains to a method for forming a complex of starch, hydrocolloid and polyvinyl alcohol having cross-linked hydroxy groups in a corrugating adhesive, such as commercially available corrugating adhesives. The method comprises adding hydrocolloid, such as hemicellulose, and polyvinyl alcohol to a corrugating adhesive having at least starch, caustic and boron containing compound, such as boric acid or borax, and mixing at a temperature of between about 80° F. to about 130° F. The starch is preferably cooked in the method. This method allows complex formation at the corrugator. Preferably, the corrugating adhesive has a content of boron containing compound of about 0.1% to about 2% and a content of caustic of about 0.2% to about 5%.

### EXAMPLES

### Example 1

A carrier adhesive comprising a starch, hemicellulose and polyvinyl alcohol complex was made by combining 15 grams of hemicellulose, 30 grams of modified starch (Stablebond® (from Corn Products), 2.5 grams of polyvinyl alcohol (CELVOL® 203 from Celanese Chemicals), 4 grams of 10 mol borax (laboratory grade from Fisher Scientific, Hampton, N.H., U.S.A.), 26 milliliters of a 25.5% sodium hydroxide solution (laboratory grade from Fisher Scientific) and 440 grams of water in a mixer. The contents were then mixed at a shear rate of 200 rpm in boiling water bath for 30 minutes to cook the starch to obtain the complex.

The carrier adhesive comprising starch made in this example was analyzed by size exclusion chromatography to determine its molecular weight distribution. The adhesive composition was treated with 2 liters of ethanol to precipitate the high molecular weight fractions. The precipitate was then filtered and dried. Precipitation was necessary to remove low molecular weight components (typically the excess alkali used in the adhesive primary) which would otherwise damage the chromatography columns.

The corrugating adhesive precipitate was dissolved in water at 5% solids content in a boiling water bath with agitation to reconstitute the corrugating adhesive. This paste was then diluted one to ten with DMSO.

### Example 2

Comparative compositions were made. Comparison Composition A was made with 15 grams of hemicellulose, 2.5 grams of polyvinyl alcohol (CELVOL® 203 from Celanese Chemicals), 0.4 grams of 10 mol borax (laboratory grade from Fisher Scientific) and sufficient sodium hydroxide to make the solution pH 11.5. This mixture was stirred at 5% solids in water at 100° F. for 15 minutes and then diluted one to ten with DMSO. Comparison Composition B was made with 2.5 grams of polyvinyl alcohol (CELVOL® 203 from Celanese Chemicals) and 4 grams of 10 mol borax (laboratory grade from Fisher Scientific) at 5% solids in water with a pH of 11.5, and then diluted one to ten with DMSO. Separate solutions of modified corn starch (STABLEBOND® from Corn Products), polyvinyl alcohol (CELVOL® (from Celanese Chemicals) and hemicellulose were made at 5% solids and diluted one to ten with DMSO (hereinafter referred to as the “STABLEBOND® DMSO Solutions”).

The corrugating adhesive of Example 1, Comparison Composition A, Comparison Composition B, and the STABLEBOND® DMSO Solutions were all subjected to size exclusion chromatography. Size Exclusion Chromatography was performed in accordance with the procedures disclosed in Stone, Robert G. and Krasowski, Joseph A., Determination of Molecular Size Distributions of Modifed Com Starch by Size Exclusion Chromatography published in Analytical Chemistry at Anal. Chem., 1981, 53, 736-737, which is incorporated in its entirety by reference. The method employed uses a 75%:25% DMSO/aqueous phosphate eluant and silica Synchropak GPC columns. The solvent system used was 3 parts DMSO and 1 part 0.01M aqueous Sodium Phosphate at pH 7. The operating conditions were 0.2 mls/min flow through a three column system consisting of Synchropak columns (2 GPC 500 and 1 GPC 100) heated to 50° C. Otherwise, all parameters and procedures were the same as that set forth in Determination of Molecular Size Distributions of Modifed Corn Starch by Size Exclusion Chromatography.

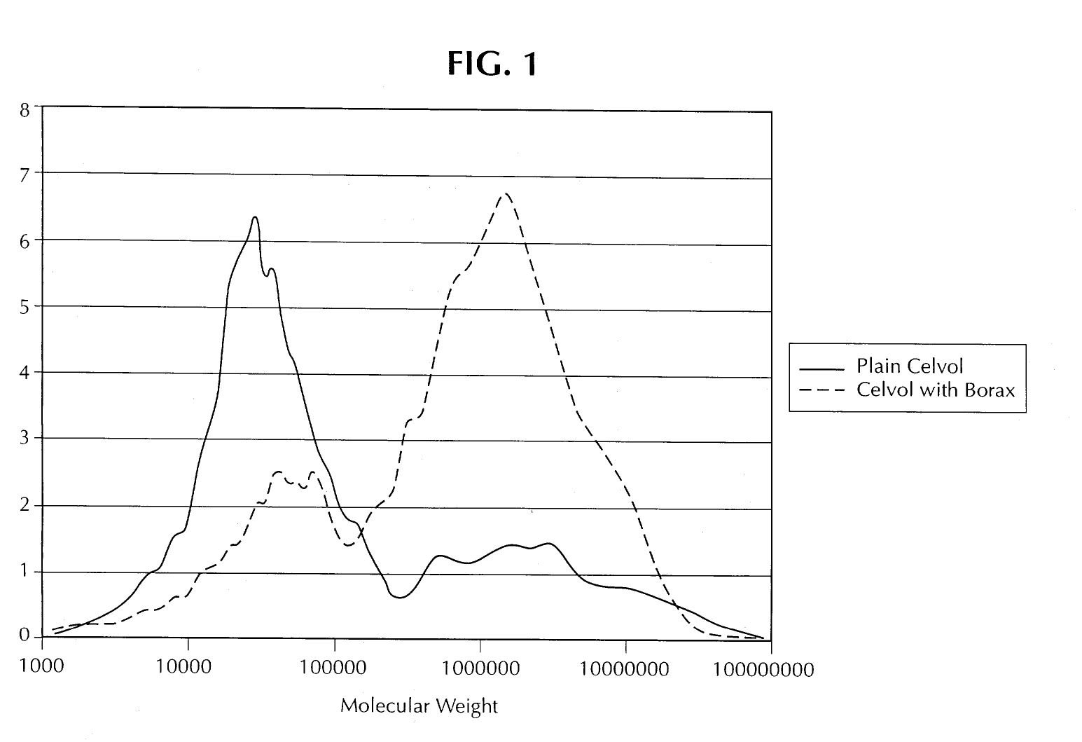

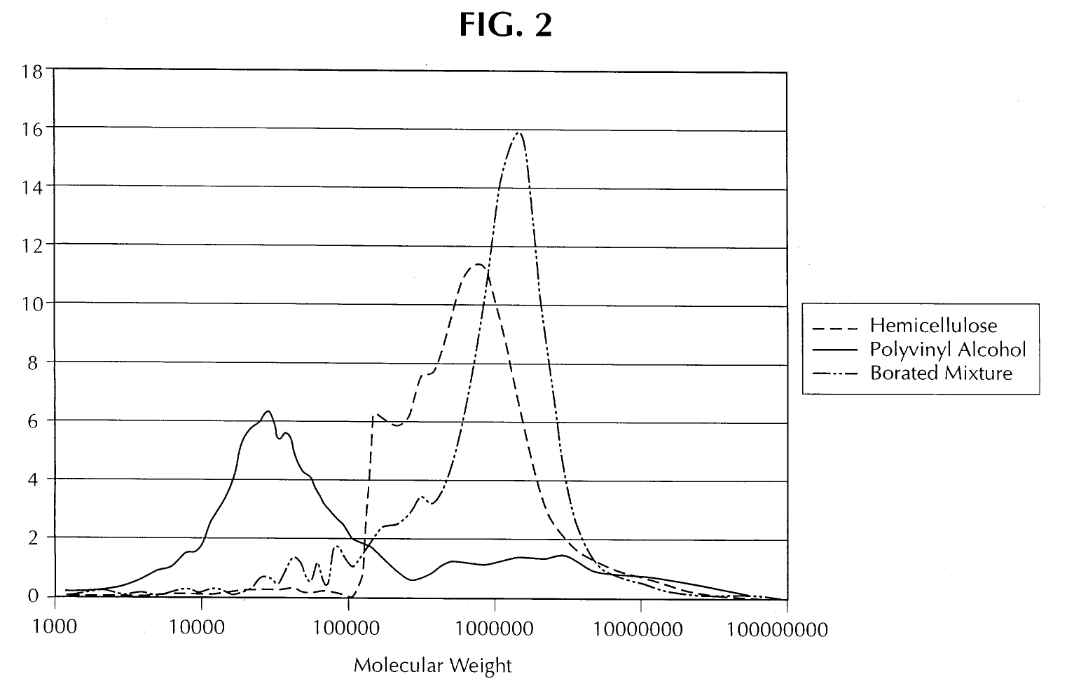

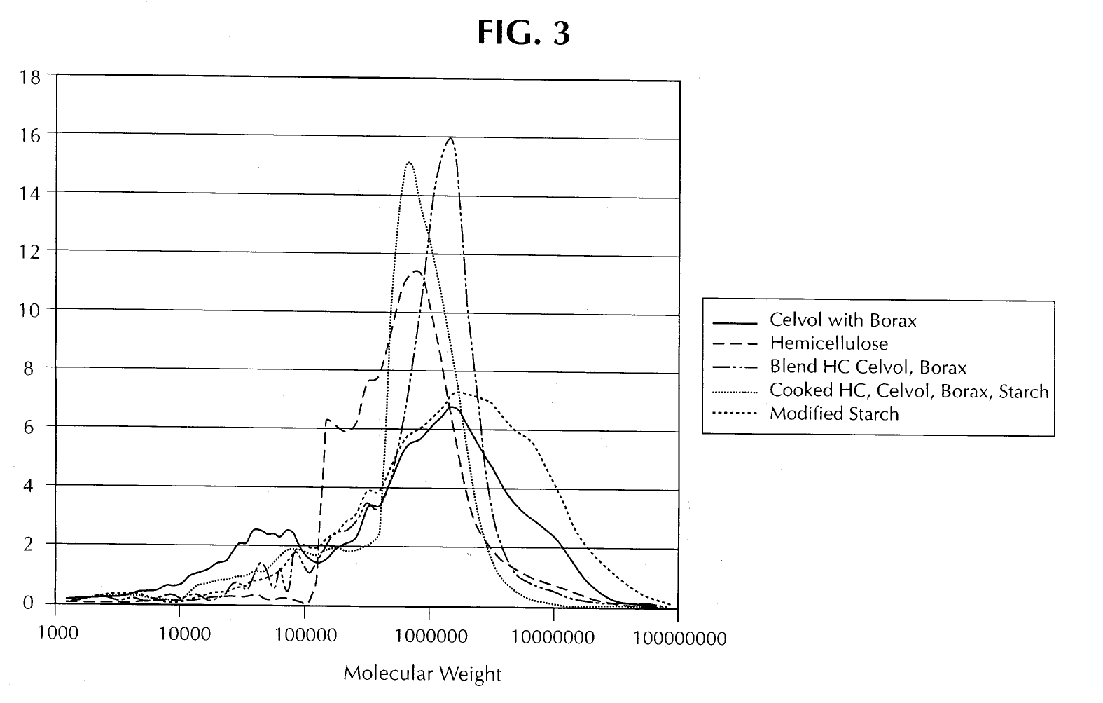

The results of the size exclusion chromatography are set forth in FIGS. 1-3. The cross-linking of polyvinyl alcohol is indicated by a shift in higher molecular weight as shown by FIG. 1. FIG. 2 demonstrates that when hemicellulose, polyvinyl alcohol and borax are combined at an alkali pH, the new compound of the invention is formed with a much narrower molecular weight distribution at a measurably higher molecular weight. FIG. 3 illustrates the complex of the invention when starch is also added and the complete adhesive is exposed to additional temperatures and shear. The process of cooking the combination of starch, hemicellulose and polyvinyl alcohol creates a component of the corrugating adhesive that is different from its constituents which is a distinct compound in the adhesive, and thus is a complex of starch, hemicellulose and polyvinyl alcohol which is cross-linked due to the presence of the borax. This complex has a narrow average molecular weight distribution that is lower than the molecular weight distribution achieved with the blend of hemicellulose, polyvinyl alcohol and borax (Comparison Composition B) notwithstanding the addition of starch to the complex. While not wishing to be bound to any theory, the inventor believes that this is partially due to the influence of the starch molecular weight and partially to shear thinning from the high pH cooking conditions.

### Example 3

A corrugating adhesive comprising the starch, hemicellulose and polyvinyl alcohol complex was made as follows. Five hundred and twenty four pounds of water heated to at 100° F. were combined with 100 pounds of FIBERBOND® starch hemicellulose blend (from Corn Products), 5 pounds of polyvinyl alcohol (CELVOL® 203 from Celanese Chemicals) and 27.5 pounds of 50% liquid caustic solution (laboratory grade from Fisher Scientific) in a mixer, and the contents were mixed 5 minutes. Then, 7.3 pounds of 5 mol Borax (laboratory grade from Fisher Scientific) was added with continued mixing for 3 ½ minutes. Next, 800 pounds of water heated to 100° F. and 435 pounds of unmodified corn starch (from Corn Products) was added to the mixer with continued mixing for 2 minutes to form the corrugating adhesive comprising the complex of the invention. The corrugating adhesive had a Stein Hall viscosity of 23 seconds at 106° F. and a gel temp of 144° F.

What is claimed is:

1. A corrugating adhesive comprising from about 15% to about 45% starch, about 1% to about 20% hydrocolloid, about 0.1% to about 10% polyvinyl alcohol, alkali to obtain a pH of about 10 to about 14, about 1% to about 3% boron containing compound and about 50% to about 80% water wherein the starch, hydrocolloid and polyvinyl alcohol are a complex having cross-linked hydroxyl groups.

2. The corrugating adhesive of claim 1 wherein the starch is cooked.

3. The corrugating adhesive of claim 1 further comprising up to about 5% waterproofing or water resistant resins and up to about 5% biocides.

4. The corrugating adhesive of claim 1 wherein the starch is selected from the group consisting of corn, wheat, barley, tapioca, rice and potato.

5. The corrugating adhesive of claim 4 wherein the starch is modified starch selected from the group consisting of high amylose corn starch, waxy corn starch, acid thinned starch, hypochlorite-oxidized starch, etherified starch, esterified starch and cross-bonded starch.

6. The corrugating adhesive of claim 1 wherein the hydrocolloid is selected from the group consisting of hemicellulose, gum arabic, xanthan gum, gum karaya, tragacanth, sodium alginates, carageenan, Guar gum, Locus bean gum, tara, pectins, gellan, cellulose derivatives, microcrystalline cellulose and combinations thereof.

7. The corrugating adhesive of claim 6 wherein the cellulose derivative is carboxymethyl cellulose, methyl cellulose or ethyl cellulose.

8. The corrugating adhesive of claim 1 wherein the boron containing compound is boric acid or borax.

9. A process for making a no-carrier corrugating adhesive comprising the steps of admixing for about 5 minutes to about 60 minutes, from about 1% to about 20% hydrocolloid, about 15% to about 45% starch, about 0.1% to about 10% polyvinyl alcohol, about 1% to about 3% boron containing compound, about 50% to about 80% water and alkali to obtain a pH of about 10 to about 14 and a temperature of about 800 to about 130° F. to form a starch, hydrocolloid and polyvinyl alcohol complex having cross-linked hydroxyl groups.

10. The process of claim 9 wherein the starch is cooked.

11. The process of claim 9 comprising the additional step of extracting the hydrocolloid in situ from fiber by adding from about 1% to about 10% fiber to the mixer prior to the admixing.

12. The process of claim 11 wherein the amount of the polyvinyl alcohol is about 0.1% to about 2%.

13. The process of claim 9 wherein the starch is pearl starch.

14. The process of claim 9 wherein the boron containing compound is boric acid or borax.

15. A process for making a carrier or carrier no-carrier corrugating adhesive comprising the steps of:
a) mixing water, starch, polyvinyl alcohol and hydrocolloid for at least about 1 minute at a temperature of from about 115° F. to about 180° F. in a primary mixer;
b) adding an aqueous solution of caustic to attain a pH from about 10 to about 14 to the primary mixer and continue mixing for at least about 10 minutes;
c) adding additional water to the primary mixer and continue mixing for at least about 1 minute to make a carrier phase;
d) heating water to about 70° F. to about 105° F. in a secondary mixer, and adding boron containing compound to the heated water;
e) adding starch to the secondary mixer and mixing for from about 3 minutes to about 25 minutes to make a suspended phase; and
f) gradually adding the contents of the primary mixer to the secondary mixer with continuous mixing at temperature of about 80° F. to about 120° F. to obtain the corrugating adhesive comprising a starch, hydrocolloid and polyvinyl alcohol complex having cross-linked hydroxyl groups.

16. The process of claim 15 wherein the starch is cooked.

17. The process of claim 15 wherein the boron containing compound is added to the primary mixer in addition to or in place of the addition of the boron containing compound in step d) of the process.

18. The process of claim 15 wherein the hydrocolloid is hemicellulose obtained in situ from corn fiber by adding from about 20% to about 50% corn fiber by weight of the carrier components to the primary mixer prior to the mixing in step a) of the process.

19. The process of claim 18 wherein the amount of polyvinyl alcohol is from about 2% to about 4% by weight of the carrier components.

20. The process of claim 15 wherein the boron containing compound is boric acid or borax.

21. A method of making a corrugated board comprising joining by bonding a corrugated board to at least one liner using the corrugating adhesive of claim 1.

22. The corrugated board made by the method of claim 21.

23. An additive for increasing tackiness of corrugating adhesives comprising a complex of cooked starch, hydrocolloid and polyvinyl alcohol having cross-linked hydroxyl groups.

24. The additive of claim 23 wherein the hydrocolloid is selected from the group consisting of hemicellulose, gum arabic, xanthan gum, gum karaya, tragacanth, sodium alginates, carageenan, Guar gum, Locus bean gum, tara, pectins, gellan, cellulose derivatives, microcrystalline cellulose and combinations thereof.

25. A process for making an additive for increasing tackiness of corrugating adhesives comprising the steps of mixing at least starch, hydrocolloid, polyvinyl alcohol, water, alkali and boron containing compound at a temperature of from about 80° F. to about 160° F. to form a cooked starch, hydrocolloid and polyvinyl alcohol complex having cross-linked hydroxyl groups.

26. The process of claim 25 wherein the hydrocolloid is selected from the group consisting of hemicellulose, gum arabic, xanthan gum, gum karaya, tragacanth, sodium alginates, carageenan, Guar gum, Locus bean gum, tara, pectins, gellan, cellulose derivatives, microcrystalline cellulose and combinations thereof.

27. A method of forming a complex of cooked starch, hydrocolloid and polyvinyl alcohol having cross linked hydroxyl groups in a corrugating adhesive having at least starch, caustic and boron containing compound comprising the step of adding hydrocolloid and polyvinyl alcohol to the corrugating adhesive and mixing at a temperature of about 80° F. to about 130° F.

28. The method of claim 27 wherein the hydrocolloid is selected from the group consisting of hemicellulose, gum arabic, xanthan gum, gum karaya, tragacanth, sodium alginates, carageenan, Guar gum, Locus bean gum, tara, pectins, gellan, cellulose derivatives, microcrystalline cellulose and combinations thereof.

29. The method of claim 27 wherein the boron containing compound is boric acid or borax.

30. The method of claim 27 wherein the content of the boron containing compound in the corrugating adhesive is about 0.1% to about 2%.

31. The method of claim 27 wherein the content of the caustic in the corrugating adhesive is about 0.2% to about 5%.
